(19) United States
(12) Patent Application Publication
(10) Pub. No.: US 2017/0198087 A1
(43) Pub. Date: Jul. 13, 2017

(54) POLYURETHANE

(71) Applicant: CRODA INTERNATIONAL PLC, Yorkshire (GB)

(72) Inventors: ANGELA LEONARDA MARIA SMITS, ZEIST (NL); WILHELMUS ADRIANUS JACOBUS HONCOOP, BERGAMBACHT (NL); LEO VAN DONGEN, ROTTERDAM (NL)

(21) Appl. No.: 15/106,567

(22) PCT Filed: Dec. 11, 2014
(86) PCT No.: PCT/GB2014/053662

§ 371 Date: Jun. 20, 2016

(30) Foreign Application Priority Data
Dec. 23, 2013 (GB) 1322936.4

(51) Int. Cl. C08G 18/75; C08G 18/42; C08G 18/34; C09J 175/06; C08G 18/10; C08G 18/32

(52) U.S. Cl. CPC C08G 18/755; C08G 18/10; C08G 18/3206; C08G 18/348; C09J 175/06; C08G 18/42

(57) ABSTRACT

A polyurethane obtainable by reacting a polyisocyanate, a polyol, and/or a chain extender, wherein at least one of the polyisocyanate and chain extender comprises a C14 to C32 alkyl group. The polyurethane is particularly suitable for use in coating, elastomer and adhesive/sealant compositions.

### FIELD OF INVENTION

The present invention relates to a polyurethane, a process of making the polyurethane, and in particular to the use thereof in coatings, elastomers and/or adhesives/sealants.

### BACKGROUND

Polyurethanes are extremely versatile materials and have been used in a wide variety of applications such as foam insulation, car seats, adhesives, paint coatings and abrasion resistant coatings. Polyurethanes may be used in protective coatings (e.g. to wood, metal, plastic), adhesives to rigid substrates (e.g. composites, metal), in applications that require moisture-resistance (e.g. in outdoor use, in sealing, in electronics), and in tough and wear-resistant elastomers.

Polyurethanes are used in a wide variety of forms, for example as dispersions; non-cellular materials such as elastomers; and cellular materials such as low density flexible foams, high density flexible foams, and microcellular foams.

Polyurethane dispersions are used in paint coating compositions. Such coating compositions provide surface protective and/or decorative coatings which may be applied to substrates and allowed to dry or cure to form continuous protective and decorative films. Such coatings may be applied to a wide variety of substrates including metals, wood, plastics, and plaster. Important properties of the formed film include hardness and resistance to water.

Polyurethane dispersion polymers are an important class of binders for aqueous coating compositions, as they produce excellent properties, such as chemical and stain resistance, hardness and toughness in the solid coating.

Polyurethane elastomers are used in cabling, tubing, belting, sportswear (e.g. sports shoes, goggles, ski boots), films/sheets, automotive interiors (e.g. grips, armrests, consoles).

Polyurethanes, both in dispersion and non-dispersion forms, are also known to find use in adhesives, for example in hotmelt adhesives.

Hotmelt adhesives are adhesives which are solid at room temperature and which can be applied in the form of a melt, usually at temperatures in the range from 80 to 250° C. Moisture-curing hotmelt adhesives may also be employed. Hotmelt adhesives can be used to adhere a wide range of materials, such as polar substrates like paper, wood and metal, and low-energy substrates such as polyolefins. An obvious benefit is the absence of any solvent, which makes hot melt adhesives a technology of increasing importance. Polyurethane hotmelt adhesives have certain advantages over other materials, such as versatility in use due to low melting temperature, and good mechanical properties after curing has taken place.

Microcellular foams have been used for energy absorbing bumper mountings and auxiliary suspension units for wheels, and in particular in shoe soles.

There is a need for polyurethanes to have improved properties such as increased strength, hardness, rigidity, crystallinity, UV-stability, colour stability, chemical resistance, and/or moisture resistance.

### SUMMARY OF THE INVENTION

We have now surprisingly discovered a polyurethane which reduces or substantially overcomes at least one of the aforementioned problems.

Accordingly, the present invention provides a polyurethane obtainable by reacting a polyisocyanate, a polyol, and/or a chain extender, wherein at least one of the polyisocyanate and chain extender comprises a C14 to C32 alkyl group.

The invention also provides a process for preparing a polyurethane which comprises reacting a polyisocyanate, a polyol and/or a chain extender, wherein at least one of the polyisocyanate and chain extender comprises a C14 to C32 alkyl group.

The invention further provides an adhesive and/or sealant composition comprising a polyurethane which comprises the reaction residues of a polyisocyanate, a polyol, and/or a chain extender, wherein at least one of the polyisocyanate and chain extender comprises a C14 to C32 alkyl group, wherein the polyisocyanate optionally comprises an aromatic polyisocyanate.

The invention still further provides an elastomer composition comprising a polyurethane which comprises the reaction residues of a polyisocyanate, a polyol, and/or a chain extender, wherein at least one of the polyisocyanate and chain extender comprises a C14 to C32 alkyl group, wherein the polyisocyanate optionally comprises an aromatic polyisocyanate.

The invention yet further provides the use of a polyisocyanate and/or chain extender comprising a C14 to C32 alkyl group to form a polyurethane having improved hardness and/or chemical resistance.

The C14 to C32 alkyl group component of the polyisocyanate and/or chain extender used to produce the polyurethane may originate from a dicarboxylic acid, diol and/or diamine. The diol or diamine may be derived from a diacid or dialkyl ester which is obtained by a metathesis reaction, preferably a self-metathesis reaction.

The metathesis reaction may occur in the presence of a catalyst. Suitable metathesis catalysts and reactions are disclosed in WO 2008/065187 and WO 2008/034552, and these documents are incorporated herein by reference.

Particularly preferred examples of suitable catalysts may be selected from:

[1,3-bis(2,6-diisopropylphenyI)-2-imidazolidinylidene]dichloro [2-(1-methylacetoxy) phenyl]methyleneruthenium(II);

[1,3-bis(2,4,6-trimethylphenyI)-2-imidazolidinylidene]dichloro [2-(1-methylacetoxy) phenyl]methyleneruthenium(II);

[1,3-bis(2,6-diisopropylphenyI)-2-imidazolidinylidene]dichloro[[2-(2-oxopropoxy) phenyl]methylene]ruthenium(II);

[1,3-bis(2,4,6-trimethylphenyI)-2-imidazolidinylidene]dichloro[[2-(2-oxopropoxy) phenyl]methylene]ruthenium(II);

([1,3-bis(2,4,6-trimethylphenyI)-2-imidazolidinyliden]dichloro[(2-isopropoxy)(5-trifluoracetamido)benzylide]]ruthenium(II);

([1,3-bis(2,6-diisopropylphenyl)-2-imidazolidinylider]dichloro[(2-isopropoxy)(5-trifluoracetamido)benzyliden]]ruthenium(II));

([1,3-bis(2,6-diisopropylphenyl)-2-imidazolidinylider]dichloro[(2-isopropoxy)(5-isobutoxyacetamido)benzyliden]]ruthenium(II));

([1,3-bis(2,4,6-trimethylphenyl)-2-imidazolidinylider]dichloro[(2-isopropoxy)(5-isobutoxyacetamido)benzylideruthenium(

([1,3-bis(2,6-diisopropylphenyl)-2-imidazolidinylider]dichloro[(2-isopropoxy)(5-ethylesteracetamido)benzyliden]]ruthenium(II)); or

((1,3-bis(2,6-diisopropylphenyl)-imidazolidin-2-yliden)((2-ethyl-3-oxo-3,4,-dihydr-2H-benzo[b][1,4]oxazin-8-yl)methylene)ruthenium(II)chlorid).

The metathesis reaction may use a fatty acid as a feedstock. The fatty acid may be from a renewable and/or bio-based source. The level of this may be determinable by ASTM D6866 as a standardised analytical method for determining the bio-based content of samples using ¹⁴C radiocarbon dating. ASTM D6866 distinguishes carbon resulting from bio-based inputs from those derived from fossil-based inputs. Using this standard, a percentage of carbon from renewable sources can be calculated from the total carbon in the sample.

The polyisocyanate component is suitably at least one isocyanate which has a functionality of at least 2. Polyisocyanates normally used in polyurethanes may be aliphatic isocyanates such as hexamethylene 1,6-diisocyanate, but usually aromatic isocyanates are used such as tolylene diisocyanate, m-phenylene diisocyanate, p-phenylene diisocyanate, xylylene diisocyanate, 4,4′-diphenylmethane diisocyanate (MDI), hexamethylene diisocyanate, isophorone diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, or modified compounds thereof such as uretonimine-modified compounds thereof. The polyisocyanate monomers can be used alone or as mixtures thereof.

In one embodiment of the invention, the polyisocyanate comprises a C14 to C30, preferably a C14 to C28, more preferably a C16 to C26, particularly a C16 to C24, and especially a C16 and/or C18 alkyl group. The alkyl group may be linear or branched, and is preferably linear. Thus, the polyisocyanate can be of the Formula (1);

OCN(CH₂)ₙNCO (1)

wherein n is suitably in the range from 14 to 30, preferably 14 to 28, more preferably 16 to 26, particularly 16 to 24, and especially 16 and/or 18.

In one preferred embodiment, n is suitably in the range from 14 to 24, preferably 14 to 22, more preferably 16 to 20, particularly 16 and/or 18, and especially 16. Thus, one particularly preferred polyisocyanate of Formula (1) comprises, consists essentially of, or consists of heptadecane 1,16-diisocyanate.

In another preferred embodiment, n is suitably in the range from 20 to 30, preferably 22 to 28, more preferably 22 to 26, particularly 24 to 26, and especially 24. Thus, one particularly preferred polyisocyanate of Formula (1) comprises, consists essentially of, or consists of hexacosane 1,24-diisocyanate.

The polyisocyanate of Formula (1) preferably has a high renewable carbon content, more preferably in the range from 50 to 100%, particularly 75 to 100%, and especially 85 to 100% renewable carbon content, as determined by ASTM-D6866 method.

In one embodiment, the polyurethane according to the invention is formed from substantially only polyisocyanate of Formula (1), i.e. the polyisocyanate used in the reaction to form the polyurethane consists essentially of or consists of polyisocyanate of Formula (1).

In an alternative embodiment, both polyisocyanate of Formula (1) and polyisocyanate not of Formula (1), preferably aromatic polyisocyanate, may be used to form the polyurethane. Preferred aromatic polyisocyanate is selected from the group consisting of 4,4′-diphenylmethane diisocyanate (MDI), hexamethylene diisocyanate, isophorone diisocyanate, polymethylenepolyphenyl diisocyanate, 3,3′-dimethyl-4,4′-biphenylene diisocyanate, and 3,3′-dimethyl-4,4′-diphenylmethane diisocyanate, more preferably MDI.

The weight ratio of polyisocyanate of Formula (1) to polyisocyanate not of Formula (1), suitably aromatic polyisocyanate, is preferably in the range from 1:0 to 30, more preferably 1:0 to 20, particularly 1:2 to 10, and especially 1:3.5 to 4.5.

The polyisocyanates described herein, particularly of Formula (1), can be made by methods known in the art, e.g. from the di-acid (or di-methyl ester) via the amide; or from the diamine by using the phosgene process.

The polyols used in polyurethanes are generally either hydroxyl-terminated polyethers or hydroxyl-terminated polyesters. The polyols have been developed to have the necessary reactivity with the polyisocyanate to produce polyurethanes with specific properties.

The choice of polyol, especially the number of reactive hydroxyl groups per polyol molecule and the size and flexibility of its molecular structure, ultimately control the degree of cross-linking between molecules which can have an important effect on the mechanical properties of the resultant polyurethane.

Polyether polyols can be made by the reaction of propylene oxide and/or ethylene oxide with active hydrogen containing starter compounds such as dipropylene glycol, glycerine, sorbitol, sucrose, ethylenediamine and/or triethanolamine. Poly(tetramethylene ether) glycol (PTMEG) is an important polyether polyol used in polyurethane synthesis.

Polyester polyols are normally made by the polycondensation of multifunctional carboxylic acids and hydroxyl compounds. Conventional polyester polyols are manufactured by the direct polyesterification of high-purity diacids and glycols, such as adipic acid and 1,4-butanediol. The polyurethane of the present invention is preferably formed from polyester polyol.

Specialty polyols include polycarbonate polyols, polycaprolactone polyols, polybutadiene polyols, and polysulfide polyols. The materials can be used in elastomer, sealant, and adhesive applications that require superior weatherability, and resistance to chemical and environmental attack.

In one preferred embodiment, the polyester polyol used in the present invention is formed from, i.e. comprises the reaction product of, at least one dimer fatty acid and/or dimer fatty diol and/or equivalent thereof. Polyester is normally produced in a condensation reaction between at least one polycarboxylic acid and at least one polyol. Dicarboxylic acids and diols are preferred. The preferred dicarboxylic acid component of the polyester polyol comprises at least one dimer fatty acid.

The term dimer fatty acid is well known in the art and refers to the dimerisation product of mono- or polyunsaturated fatty acids and/or esters thereof. Preferred dimer fatty acids are dimers of C₁₀ to C₃₀, more preferably C₁₂ to C₂₄, particularly C₁₄ to C₂₂, and especially C₁₈ alkyl chains. Suitable dimer fatty acids include the dimerisation products of oleic acid, linoleic acid, linolenic acid, palmitoleic acid, and elaidic acid. The dimerisation products of the unsaturated fatty acid mixtures obtained in the hydrolysis of natural fats and oils, e.g. sunflower oil, soybean oil, olive oil, rapeseed oil, cottonseed oil and tall oil, may also be used. Hydrogenated, for example by using a nickel catalyst, dimer fatty acids may also be employed.

In addition to the dimer fatty acids, dimerisation usually results in varying amounts of oligomeric fatty acids (so-called “trimer”) and residues of monomeric fatty acids (so-called “monomer”), or esters thereof, being present. The amount of monomer can, for example, be reduced by distillation. Particularly preferred dimer fatty acids, used to form the polyester component of the polyurethane according to the present invention, have a dicarboxylic (or dimer) content of greater than 45%, more preferably greater than 60%, particularly greater than 70%, and especially greater than 75% by weight. The trimer content is preferably less than 55%, more preferably in the range from 5 to 40%, particularly 10 to 30%, and especially 15 to 25% by weight. The monomer content is preferably less than 10%, more preferably in the range from 0.5 to 5%, particularly 1 to 4%, and especially 2 to 3% by weight. All of the above % by weight values are based on the total weight of trimer, dimer and monomer present.

The dicarboxylic acid component of the polyester may also comprise non-dimeric dicarboxylic acids (hereinafter referred to as non-dimeric acids). The non-dimeric acids may be aliphatic or aromatic, and include dicarboxylic acids and the esters, preferably alkyl esters, thereof, preferably linear dicarboxylic acids having terminal carboxyl groups having a carbon chain in the range from 2 to 20, more preferably 6 to 12 carbon atoms, such as succinic acid, adipic acid, glutaric acid, succinic acid, pimelic acid, suberic acid, azelaic acid, sebacic acid, heptane dicarboxylic acid, octane dicarboxylic acid, nonane dicarboxylic acid, decane dicarboxylic acid, undecane dicarboxylic acid, dodecane dicarboxylic acid and higher homologs thereof. Succinic acid, adipic acid, sebacic acid and/or decane dicarboxylic acid are particularly preferred.

A monomeric dicarboxylic acid anhydride, such as phthalic anhydride, may also be employed as the or as part of the non-dimeric acid component.

The polyester is preferably formed from dimer fatty acids to non-dimer acids present at a ratio in the range from 10 to 100:0 to 90%, more preferably 30 to 70:30 to 70%, and particularly 40 to 60:40 to 60% by weight of the total dicarboxylic acids.

The polyol component of the polyester polyol used in the present invention is suitably of low molecular weight, preferably in the range from 50 to 650, more preferably 70 to 200, and particularly 100 to 150. The polyol component may comprise polyols such as pentaerythritol, triols such as glycerol and trimethylolpropane, and preferably diols. Suitable diols include straight chain aliphatic diols such as ethylene glycol, diethylene glycol, 1,3-propylene glycol, dipropylene glycol, 1,4-butylene glycol, 1,6-hexylene glycol, branched diols such as neopentyl glycol, 3-methyl pentane glycol, 1,2-propylene glycol, and cyclic diols such as 1,4-bis(hydroxymethyl)cyclohexane and (1,4-cyclohexane-dimethanol). 1,4-butylene glycol, 1,6-hexylene glycol, neopentyl glycol and/or diethylene glycol are preferred diols.

The polyol component may also comprise a dimer fatty diol. Dimer fatty acids are mentioned above in relation to the dicarboxylic acid component, and dimer fatty diols can be produced by hydrogenation of the corresponding dimer fatty acid. The same preferences above for the dimer fatty acid apply to the corresponding dimer fatty diol component of the polyester.

The polyol component may also comprise a 1,4:3,6 dianhydrohexitol. Preferred 1,4:3,6 dianhydrohexitols are mannitol, sorbitol and iditol, which are commonly known as isomannide, isosorbide and isoidide after the relevant parent hexitol. Isosorbide (or 1,4:3,6 dianhydro-D-sorbitol) is particularly preferred. Isosorbide can be conveniently made from renewable resources such as sugars and starches, for example from D-glucose by hydrogenation followed by acid catalysed dehydration.

The polyester polyol is preferably formed from dicarboxylic acid to diol starting materials at a molar ratio in the range from 1:1.0 to 5.0, more preferably 1:1.2 to 3.0, and particularly 1:1.3 to 2.0. In one embodiment, the diol is present in molar excess so as to obtain polyester terminated at both ends with OH groups.

In one embodiment, the polyester polyol is formed from, i.e. comprises the reaction product of, dimer fatty acid, adipic acid, and 1,6-hexylene glycol, preferably at a molar ratio in the range from 0.01 to 1:0.1 to 1:1, more preferably 0.05 to 0.75:0.2 to 0.75:1, and particularly 0.1 to 0.2:0.4 to 0.6:1.

The polyester polyol preferably has a molecular weight (number average) in the range from 1,000 to 6,000, more preferably 1,200 to 4,000, particularly 1,500 to 3,000, and especially 1,900 to 2,200.

The polyester polyol preferably has a glass transition temperature (Tg) in the range from −75 to -10° C., more preferably −70 to -30° C., particularly −65 to -50° C., and especially −60 to -55° C.

The polyester polyol preferably has a hydroxyl value (measured as described herein) in the range from 10 to 100, more preferably 30 to 80, and particularly 40 to 70 mgKOH/g. In addition, the polyester polyol preferably has an acid value (measured as described herein) of less than 2, more preferably less than 1.5, and particularly less than 1.0.

In one embodiment of the invention, at least one of the aforementioned polyisocyanates, preferably of Formula (1), is reacted with at least one of the aforementioned polyester polyols, to form a prepolymer. The molar ratio of polyisocyanate to polyester polyol starting materials which are mixed together to react to form the prepolymer is preferably in the range from 20 to 80:20 to 80%, more preferably 35 to 75:25 to 65%, particularly 45 to 70:30 to 55%, and especially 55 to 70:30 to 45%. The polyisocyanate is preferably used in molar excess relative to OH group content of the polyester, so as to obtain an isocyanate-terminated prepolymer and sufficient unreacted polyisocyanate, such that later addition of the chain extender can result in reaction to form the polyurethane, without the requirement for adding further polyisocyanate.

The prepolymer may also be used without the addition of chain extender, by moisture-curing (using atmospheric water, or by introducing water vapour) to form the polyurethane. The prepolymer may also be used in a 2-component system (e.g. as a coating, adhesive, or cast elastomer), by reacting with additional polyol and/or chain extender as a second component.

The prepolymer reaction mixture preferably has an isocyanate content (measured as described herein) in the range from 5 to 30%, more preferably 10 to 25%, particularly 12 to 20%, and especially 14 to 19% NCO.

The chain extender components normally used to form polyurethane comprises a low molecular compound having 2 or more active hydrogen groups, for example polyols such as ethylene glycol, diethylene glycol, propylene glycol, 1,4-butylene glycol, 1,5-pentylene glycol, methylpentanediol, 1,6-hexylene glycol, neopentyl glycol, trimethylolpropane, hydroquinone ether alkoxylate, resorcinol ether alkoxylate, glycerol, pentaerythritol, diglycerol, dextrose, and a 1,4:3,6 dianhydrohexitol such as isomannide, isosorbide and isoidide; and amine-functional components such as,

(i) one or more aliphatic diamines with the number of carbon atoms in the chain of at least 4, whereby the amino groups are preferably at the terminal ends of the carbon chain. The aliphatic diamines may contain up to 20 carbon atoms and the aliphatic chain may be essentially linear or branched. The most preferred aliphatic diamines are 1,4-butane diamine, 1,6-hexamethylene diamine, 1,8-diamino octane or 1,12-diamino dodecane;

(ii) one or more cyclic diamines and/or heterocyclic diamines. Examples for cyclic (aliphatic) diamines or heterocyclic diamines are cyclohexanediamine, 4,4′ diamino dicyclohexyl-methane, xylenediamine, piperazine, cyclohexanebis(methylamine), isophorone diamine, dimethylpiperazine and dipiperidylpropane, dimer diamines (e.g. Priamine™, ex Croda);

(iii) aromatic polyhydric amines such as methylene-bis(2-chloroaniline), methylenebis(dipropylaniline), diethyl-toluenediamine, trimethylene glycol di-p-aminobenzoate;

(iv) one or more polyoxyalkylene-diamines, for example polyoxyethylene diamine, polyoxypropylenediamine or bis-(di-aminopropyl)-polytetrahydrofurane. The polyoxyalkylenediamines, also known as “Jeffamines” (ex Huntsman), are most preferred; and/or

(v) alkanolamines such as diethanolamine, triethanolamine and diisopropanolamine.

In one embodiment of the invention, the chain extender comprises a C16 to C32, preferably a C16 to C30, more preferably a C18 to C28, particularly a C18 to C26, and especially a C18 alkyl group. The alkyl group may be linear or branched, and is preferably linear.

Thus, the chain extender can be of the Formula (2);

X(CH₂)ₙX (2)

wherein each X is independently OH or NH₂, preferably OH, and n is suitably in the range from 16 to 32, preferably 16 to 30, more preferably 18 to 28, particularly 18 to 26, and especially 18.

In one preferred embodiment, n is suitably in the range from 16 to 26, preferably 16 to 24, more preferably 18 to 22, particularly 18 to 20, and especially 18. Thus, one particularly preferred chain extender of Formula (2) comprises, consists essentially of, or consists of 1,18-heptadecanediol and/or 1,18-heptadecanediamine, preferably comprises, consists essentially of, or consists of 1,18-heptadecanediol.

In another preferred embodiment, n is suitably in the range from 22 to 32, preferably 24 to 30, more preferably 24 to 28, particularly 26 to 28, and especially 26. Thus, one particularly preferred chain extender of Formula (2) comprises, consists essentially of, or consists of 1,26-hexacosanediol and/or 1,26-hexacosanediamine, preferably comprises, consists essentially of, or consists of 1,26-hexacosanediol.

The chain extender of Formula (2) preferably has a high renewable carbon content, more preferably in the range from 75 to 100%, particularly 90 to 100%, and especially 100% renewable carbon content, as determined by ASTM-D6866 method.

In one embodiment, the polyurethane according to the invention is formed from substantially only chain extender of Formula (2), i.e. the chain extender used in the reaction to form the polyurethane consists essentially of or consists of chain extender of Formula (2).

In an alternative embodiment, both chain extender of Formula (2) and chain extender not of Formula (2) may be used to form the polyurethane. Preferred chain extender not of Formula (2) is 1,4-butanediol, 1,6-hexanediol, dimer fatty diol and/or dimer fatty diamine. 1,4-butanediol and/or 1,6-hexanediol are particularly preferred.

The weight ratio of chain extender of Formula (2) to chain extender not of Formula (2) used to make the polyurethane is preferably in the range from 1:0 to 30, more preferably 1:1 to 20, particularly 1:3 to 10, and especially 1:4.5 to 5.

The molar ratio of chain extender to the prepolymer employed is preferably in the range from 0.2 to 3:1, more preferably 0.6 to 2.5:1, and particularly 1 to 2:1.

The chain extender, preferably of Formula (2), content of the polyurethane is preferably in the range from 1 to 20%, more preferably 1.5 to 15%, particularly 2 to 10%, and especially 2.5 to 5% by weight.

The isocyanate, preferably of Formula (1), content of the polyurethane is preferably in the range from 2 to 70%, more preferably 4 to 60%, and particularly 5 to 45% by weight.

The molar ratio of chain extender, preferably of Formula (2), to isocyanate, preferably of Formula (1), in the polyurethane is preferably in the range from 1 to 10:1, more preferably 1.5 to 8:1, particularly 2 to 5:1, and especially 2.5 to 4:1.

The polyol, preferably polyester polyol, content of the polyurethane is preferably in the range from 10 to 75%, more preferably 20 to 60%, and particularly 30 to 50% by weight.

The C14 to C32, preferably C16 to C26, and particularly C16 and/or C18, alkyl group content of the polyurethane is suitably in the range from 0.5 to 8%, more preferably 1 to 6%, particularly 2 to 5%, and especially 3 to 4% by weight.

The C14 to C32, preferably C16 to C26, and particularly C16 and/or C18, alkyl group content of the polyurethane is preferably derived from the polyisocyanate and/or chain extender, more preferably substantially derived from the polyisocyanate and/or chain extender, and particularly exclusively derived from the polyisocyanate and/or chain extender.

In the present invention, the polyurethane composition may optionally contain other additives such as urethane promoting catalysts, surfactants, stabilizers and pigments.

Suitable catalysts are the normal polyurethane catalysts such as compounds of divalent and tetravalent tin, more particularly the dicarboxylates of divalent tin and the dialkyl tin dicarboxylates and dialkoxylates. Examples include dibutyl tin dilaurate, dibutyl tin diacetate, dioctyl tin diacetate, dibutyl tin maleate, tin(II) octoate, tin(II) phenolate, and the acetyl acetonates of divalent and tetravalent tin. In addition, tertiary amines or amidines may also be employed, either alone or in combination with the aforementioned tin compounds. Examples of amines include tetramethyl butane diamine, bis-(dimethylaminoethyl)-ether, 1,4-diazabicyclooctane (DABCO), 1,8-diazabicyclo-(5.4.0)-undecane, 2,2′-dimorpholinodiethyl ether, dimethyl piperazine, and mixtures thereof.

Suitable surfactants include silicone surfactants such as dimethylpolysiloxane, polyoxyalkylene polyol-modified dimethylpolysiloxane and alkylene glycol-modified dimethylpolysiloxane; and anionic surfactants such as fatty acid salts, sulfuric acid ester salts, phosphoric acid ester salts and sulfonates.

Suitable stabilizers include materials which stabilize the viscosity of the polyurethane during its production, storage and application, and include monofunctional carboxylic acid chlorides, monofunctional highly reactive isocyanates, and non-corrosive inorganic acids. Examples of such stabilizers are benzoyl chloride, toluene sulfonyl isocyanate, phosphoric acid or phosphorous acid. In addition, suitable hydrolysis stabilizers include for example the carbodiimide type. Stabilizers which are antioxidants may also be used.

Suitable pigments include inorganic pigments such as transition metal salts; organic pigments such as azo compounds; and carbon powder.

The polyurethane according to the present invention may be produced by simple mixing of the prepolymer and chain extender, preferably at a NCO/OH ratio in the range from 1.5 to 5:1, more preferably 1.7 to 3:1, and particularly 1.8 to 2:1.

The polyurethane suitably has a tensile strength (measured as described herein) of greater than 20, preferably in the range from 30 to 200, more preferably 40 to 150, particularly 45 to 100, and especially 50 to 80 kgcm⁻².

The elongation at break (measured as described herein) of the polyurethane is preferably greater than 150%, more preferably greater than 200%, particularly in the range from 250 to 550% and especially 300 to 400%.

The polyurethane described herein may be used in coating, elastomer and/or adhesive/sealant compositions.

In one embodiment, a coating composition comprises a polyurethane which is formed from a polyisocyanate, a polyol, and/or a chain extender, wherein at least one of the polyisocyanate and chain extender comprises a C14 to C32 alkyl group.

In another embodiment, an elastomer composition comprises a polyurethane which is formed from a polyisocyanate, a polyol, and/or a chain extender, wherein at least one of the polyisocyanate and chain extender comprises a C14 to C32 alkyl group. The polyisocyanate component preferably comprises an aromatic polyisocyanate, e.g. as described herein.

In a further embodiment, an adhesive or sealant composition comprises a polyurethane which is formed from a polyisocyanate, a polyol, and/or a chain extender, wherein at least one of the polyisocyanate and chain extender comprises a C14 to C32 alkyl group. The polyisocyanate component preferably comprises an aromatic polyisocyanate, e.g. as described herein.

It will be understood that any upper or lower quantity or range limit used herein may be independently combined.

It will be understood that all test procedures and physical parameters described herein have been determined at atmospheric pressure and room temperature (i.e. about 20° C.), unless otherwise stated herein, or unless otherwise stated in the referenced test methods and procedures.

The invention is illustrated by the following non-limiting examples.

In this specification, the following test methods have been used.

(i) Tensile strength was determined according to ISO 37/DIN 53504 using a Z82B29 sample die. The samples were conditioned for a minimum of 24 hours, undeflected and undistorted at 23° C. and 50% relative humidity, prior to testing.

(ii) Elongation at break was measured according to ISO 37/DIN 53504 using a Z82B29 sample die. The samples were conditioned for a minimum of 24 hours, undeflected and undistorted at 23° C. and 50% relative humidity, prior to testing.

(iii) König Hardness was measured using DIN ISO 2815.

(iv) Particle size of polyurethane dispersions was measured with a Zetasizer using dynamic light scattering.

(v) Number average molecular weight was determined by end group analysis with reference to the hydroxyl value.

(vi) Weight average molecular weight was determined by end group analysis with reference to the hydroxyl value.

(vii) The isocyanate value is defined as the weight % content of isocyanate in the sample and was determined by reacting with excess dibutylamine, and back titrating with hydrochloric acid.

(viii) The hydroxyl value is defined as the number of mg of potassium hydroxide equivalent to the hydroxyl content of 1 g of sample, and was measured by acetylation followed by hydrolysation of excess acetic anhydride. The acetic acid formed was subsequently titrated with an ethanolic potassium hydroxide solution.

(ix) The acid value is defined as the number of mg of potassium hydroxide required to neutralise the free fatty acids in 1 g of sample, and was measured by direct titration with a standard potassium hydroxide solution.

(x) Water absorption is determined by measuring the weight increase of a sample after 24 hours immersion in demineralised water at room temperature.

### EXAMPLES

### Example 1

100 g methyl oleate (purified by aluminium-oxide treatment) was heated to 100° C. 13 ppm of ([1,3-bis(2,4,6-trimethylphenyl)-2-imidazolidinylider]dichloro[(2-isopropoxy)(5-trifluoracetamido)benzyliden]ruthenium(II)) was dissolved in 1 ml toluene, and this was added to the methyl oleate.

After 30 seconds, 43.6% conversion was reached, and after 120 seconds, the reaction equilibrium conversion was reached. The resulting reaction mixture contained 24.8% 9-octadecene, 25.2% 9-octadecenedioic acid dimethyl ester and approximately 50% methyl oleate according to Gas Chromatography analysis. The reaction mixture was contacted with a treated clay (5 g Tonsil 210FF) while stirring at 80° C. for 60 minutes. This mixture was filtered over filter paper to give an essentially catalyst-free product.

The catalyst-free product was purified using fractional distillation under vacuum of 2 to 9 mbar, by first distilling off the alkene and methyl oleate, and then collecting dimethyl octadecenedioate in the temperature range of 220-240° C. Gas Chromatography analysis indicated a purity of >95%.

200 g dimethyl octadecenedioate was charged into a 400 ml volume hydrogenation autoclave vessel, 0.18 g palladium 5% on carbon hydrogenation catalyst was added, and the autoclave heated to 160° C. under 15 bar of hydrogen for 45 minutes, after which the hydrogen uptake has stopped, indicating reaction completion. The catalyst was filtered, resulting in dimethyl octadecanedioate (dimethyl ester of C18 diacid) at >95% purity according to Gas Chromatography analysis.

2.9 g Zn(2-ethylhexanoate)₂(8 mmol) and 0.3 g NaBH₄ (8 mmol) were added to 150 ml diisopropyl ether and heated under nitrogen to 70° C. The mixture was stirred for 20 minutes (hydrogen evolved). 32 g dimethyl octadecanedioate (˜0.2 mol ester groups) was added and 57 g PMHS (0.88 mol) was dosed in 45 minutes. The mixture was maintained under reflux. After 4 hours, gelation of the mixture occurred. The gel was cooled and 74 g KOH dissolved in 90 g methanol was added carefully (exothermic reaction). The gel dissolved during addition. The reaction temperature increased to 50° C. 50 ml water and 50 ml ether were added and the mixture was stirred for 45 minutes. The phases were separated. The organic phase was washed with water and concentrated with the use of a rotavap. The product (8 g) was distilled using the bulb-to-bulb distillation and 7 g of distillate (OHV=387 mg KOH/g) was obtained. The water phase was washed with diethyl ether. The ether was evaporated and 10 g of 1,18-octadecanediol having a hydroxyl value of 392 mg KOH/g was obtained.

In the following examples, this 1,18-octadecanediol is referred to as C18 diol.

### Example 2

100 g methyl erucate (purified by aluminium-oxide treatment) was heated to 100° C. 105 ppm of ([1,3-bis(2,4,6-trimethylphenyl)-2-imidazolidinylider]dichloro[(2-isopropoxy) (5-trifluoracetamido)benzyliderVuthenium(II) was dissolved in 1 ml toluene, and this was added to the methyl erucate.

After 30 seconds, the reaction equilibrium conversion was reached. The resulting reaction mixture contained 20.6% 9-octadecene, 28.4% 13-hexacosenedioic acid dimethyl ester and approximately 50% methyl erucate according to Gas Chromatography analysis.

In order to produce 1,26-hexacosanediacid (C26 diacid) from this reaction mixture, the same steps were followed as given above in Example 1 for octadecanedioic acid (C18 diacid). However, the fractional distillation step was modified in that the product (dimethyl hexacosenedioiate) remained in the bottom fraction of the distillation due to its high molecular weight.

3.0 g Zn(2-ethylhexanoate)₂ (8 mmol) and 0.3 g NaBH₄ (8 mmol) were added to 300 ml diisopropyl ether and heated under nitrogen to 70° C. The mixture was stirred for 20 minutes (hydrogen evolved). 43.1 g dimethyl hexacosenedioiate (˜0.2 mol ester groups) was added and 57 g PMHS (0.88 mol) was dosed in 45 minutes. The mixture was maintained under reflux. After 7 hours, gelation of the mixture occurred. The gel was cooled and 75 g KOH dissolved in a mixture of 10 g water/200 g methanol was added carefully (exothermic reaction). The gel dissolved during addition. The reaction temperature increased to 45° C. 150 ml water was added and the mixture was stirred for 45 minutes. Toluene was added to prevent solidification of the mixture. The phases were separated. The organic phase was washed with water and concentrated with the use of a rotavap. The product was distilled using the bulb-to-bulb distillation and 23 g of 1,26-hexacosanediol having a hydroxyl value of 270 mg KOH/g was obtained.

In the following examples, this 1,26-hexacosanediol is referred to as C26 diol.

### Example 3

This is a comparative example, not according to the invention.

Ingredients:

100 g Priplast™ 3192 (polyester diol, ex Croda)

11.9 g dimethylolpropionic acid (DMPA)

3.7 g hexanediol (HDO)

59.6 g isophorone diisocyanate (IPDI)

24.5 g N-methyl pyrrolidone (NMP)

267 g water

4.5 g ethylene diamine (EDA)

8.7 g triethylamine (TEA)

The Priplast™ 3192, DMPA and NMP (solvent) were dried at 120° C. under nitrogen. After cooling to 70° C., DBTL (dibutyl tin laurate) catalyst (0.05%wt on pre-polymer) and IPDI were added (IPDI slowly) to produce a prepolymer, during approximately 3 hours. When the NCO % reached 4.1, the hexanediol was added to the reaction until the desired NCO % had been reached. TEA was then added at 60° C. to neutralize the DMPA carboxylic acid groups, during 0.5 to 1 hour, followed by cooling to 40-55° C. The resultant prepolymer was dispersed in demineralised water, by slowly adding for 1 hour under vigorous stirring. The prepolymer was chain extended at 25° C. with EDA, by adding drop-wise and reacting for 2 hours. The resulting product was a 40% solids polyurethane dispersion (PUD). Acetone was used as a processing aid, to reduce viscosity, and was distilled off from the final PUD.

### Example 4

Ingredients:

100 g Priplast™ 3192 (polyester diol, ex Croda)

11.9 g dimethylolpropionic acid (DMPA)

7.3 g C18-diol (produced in Example 1)

59.6 g isophorone diisocyanate (IPDI)

24.5 g N-methyl pyrrolidone (NMP)

267 g water

4.5 g ethylene diamine (EDA)

8.7 g triethylamine (TEA)

The procedure of Example 3 was repeated except that C18 diol was used instead of hexanediol.

### Example 5

Ingredients:

100 g Priplast™ 3192 (polyester diol, ex Croda)

11.9 g dimethylolpropionic acid (DMPA)

7.3 g C26-diol (produced in Example 2)

59.6 g isophorone diisocyanate (IPDI)

24.5 g N-methyl pyrrolidone (NMP)

267 g water

4.5 g ethylene diamine (EDA)

8.7 g triethylamine (TEA)

The procedure of Example 3 was repeated except that C26 diol was used instead of hexanediol.

### Example 6

The PUDs produced in Examples 3, 4 and 5 were subjected to various test procedures and the results are shown in Table 1.

TABLE 1

| | Example | | |
|---|---|---|---|
| | 3 (Comp) | 4 | 5 |
| Chain extender | HDO | C18 diol | C26 diol |
| Particle size | 100 nm | 97.8 nm | 74 nm |
| Konig hardness | 60 s | 78 s | 41 s |
| Water absorption | 5% | 4% | 4% |
| (24 hours/RT) | | | |
| Chemical resistance to | 5 | 3 | 2 |
| ethanol (50%, 1 hour) | | | |
| Chemical resistance to | 5 | 3-4 | 2 |
| acetic acid (1 hour) | | | |

The results in Table 1 show that compared to Comparative Example 3, the polyurethane dispersion of Example 4 has improved hardness and the polyurethane dispersions of both Examples 4 and 5 have a lower water absorption and improved chemical resistance to ethanol and acetic acid (0=undamaged, 5=complete damage).

The above examples illustrate the improved properties of a polyurethane according to the present invention.

1. A polyurethane obtained by reacting a polyisocyanate, a polyol, and/or a chain extender, wherein at least one of the polyisocyanate and chain extender comprises a C14 to C32 alkyl group.

2. A polyurethane according to claim 1 wherein the polyisocyanate and/or chain extender comprises a C16 to C26 alkyl group.

3. A polyurethane according to claim 1 wherein the polyisocyanate is of the Formula (1);
OCN(CH₂)ₙNCO (1)
wherein n is in the range from 14 to 30.

4. A polyurethane according to claim 1 wherein the polyisocyanate is heptadecane 1,16-diisocyanate.

5. A polyurethane according to claim 1 wherein the chain extender is of the Formula (2);
X(CH₂)ₙX (2)
wherein each X is independently OH or NH₂, and n is in the range from 16 to 32.

6. A polyurethane according to claim 1 wherein the chain extender is 1,18-heptadecanediol and/or 1,26-hexacosanediol.

7. A polyurethane according to claim 1 wherein the polyol comprises a polyester polyol.

8. A polyurethane according to claim 1 wherein the polyisocyanate comprises aromatic polyisocyanate.

9. A polyurethane according to claim 1 comprising 2 to 70% by weight of isocyanate of Formula (1) and/or 1 to 20 by weight chain extender of Formula (2)
wherein the polyisocyanate is of the Formula (1);
OCN(CH₂)ₙNCO (1)
wherein n is in the range from 14 to 30, and
wherein the chain extender is of the Formula (2);
X(CH₂)ₙX (2)
wherein each X is independently OH or NH₂, and n is in the range from 16 to 32.

10. A polyurethane according to claim 2 comprising 0.5 to 8% by weight of C16 to C26 alkyl groups.

11. A polyurethane according to claim 10 wherein the C16 to C26 alkyl groups are exclusively derived from polyisocyanate and/or chain extender.

12. A process for preparing a polyurethane which comprises reacting a polyisocyanate, a polyol and/or a chain extender, wherein at least one of the polyisocyanate and chain extender comprises a C14 to C32 alkyl group.

13. The process according to claim 12 wherein the polyisocyanate is reacted with the polyol to form an isocyanate-terminated prepolymer.

14. An adhesive and/or sealant composition comprising a polyurethane which comprises the reaction residues of a polyisocyanate, a polyol, and/or a chain extender, wherein at least one of the polyisocyanate and chain extender comprises a C14 to C32 alkyl group, wherein the polyisocyanate optionally comprises an aromatic polyisocyanate.

15. An elastomer composition comprising a polyurethane which comprises the reaction residues of a polyisocyanate, a polyol, and/or a chain extender, wherein at least one of the polyisocyanate and chain extender comprises a C14 to C32 alkyl group, wherein the polyisocyanate optionally comprises an aromatic polyisocyanate.

16. (canceled)

17. A polyurethane according to claim 3 wherein n is in the range from 14 to 28.

18. A polyurethane according to claim 5 wherein n is in the range from 16 to 30.

19. A polyurethane according to claim 5 wherein each X is OH.

20. A polyurethane according to claim 9 comprising 4 to 60% by weight of isocyanate of Formula (1) and/or 1.5 to 15% by weight chain extender of Formula (2).

21. A polyurethane according to claim 10 comprising 1 to 6% by weight of C16 to C26 alkyl groups.
